(19) United States
(12) Patent Application Publication
(10) Pub. No.: US 2010/0171605 A1
(43) Pub. Date: Jul. 8, 2010

(54) DEVICE AND METHOD FOR DETERMINING VEHICLE DATA

(76) Inventors: Mathias Hain, Reutlingen (DE); Nikolaos Oikonomidis, Stuttgart (DE); Thomas-Achim Boes, Wannweil (DE)

Correspondence Address: KENYON & KENYON LLP, ONE BROADWAY, NEW YORK, NY, 10004, US

(21) Appl. No.: 12/532,632

(22) PCT Filed: Jan. 28, 2008
(86) PCT No.: PCT/EP08/50941

§ 371 Date: Jan. 21, 2010

(30) Foreign Application Priority Data
Mar. 22, 2007 (DE) 10 2007 013 684.8

(51) Int. Cl. B60C 23/02

(52) U.S. Cl. 340/447; 340/442

(57) ABSTRACT

An apparatus and a method for ascertaining vehicle data, for example, tire pressure data, are provided. For example, the apparatus includes a sending unit, a receiving unit and a measuring unit. The sending unit and/or the receiving unit are battery-operated. The receiving unit is a threshold value receiver or a carrier ID receiver.

### FIELD OF INVENTION

The present invention relates to a device and method for processing vehicle data, for example, tire pressure data.

### BACKGROUND TECHNOLOGY

German Patent Application No. DE 198 53 000 A1 appears to describe a method for supplying a motor vehicle with data, in which context data are transmitted at fixed time intervals via a wireless communication device. The data must have for this purpose, for example, a end marker in order to inform the receiving unit of the end of the data transfer. However, the system configured in this fashion cannot be battery-operated, since the receiving unit must possess a complex configuration for data sensing and thus has a high energy consumption. A system configured in this fashion would therefore quickly cease to be functional after discharge of the battery.

### SUMMARY OF INVENTION

In embodiments of the present invention, a more energy-saving threshold value receiver or carrier ID receiver is used as a receiving unit. The energy consumption of the receiving unit embodiment of the present invention is thereby reduced as compared with receivers of complex configuration. Energy supply to the apparatus according to an embodiment of the present invention by using a battery is therefore possible, without substantially reducing the service life of the apparatus as a result of an exhausted battery and with no need to take costly measures for energy recovery.

Here, in describing embodiments of the present invention, a “receiving unit” is to be understood as a component for receiving signals and for sending signals. The receiving unit consequently receives or sends signals, depending on the operating mode that is set. Only the term “receiving unit” will be used hereinafter, however, since it is the receiving of signals by this component that is of interest in some embodiment methods of the present invention. The sending unit according to some embodiments of the present invention is likewise a component that both receives and sends signals. Because it is specifically the sending of signals by this component that is of interest in some embodiment methods of the present invention, the component will be referred to as a “sending unit.”

In embodiments of the present invention, if the apparatus is provided for the processing or measurement of tire pressure data, the wheel electronics encompass the receiving unit. The receiving unit is thus located physically close to the location at which the tire pressure data are measured.

In embodiments of the present invention, the apparatus has a trigger transmitter in the sending unit. In embodiments, the use of a trigger transmitter likewise reduces the energy consumption of the apparatus, since the receiving unit is not being constantly addressed by the sending unit.

In embodiments of the present invention, the sending unit transmits at a frequency from approximately 80 to 250 kHz, for example, at a frequency from approximately 110 to 150 kHz, or, for example, at a frequency from approximately 120 to 130 kHz. In embodiments of the present invention, the electromagnetic compatibility of the apparatus can thereby be improved.

A receiving unit is provided for use in apparatus embodiments of the present invention. In embodiments of the present invention, the receiving unit, the sending unit or measuring unit, can be used with other components that do not belong to an apparatus embodiment.

In embodiments of the present invention, a method for controlling the apparatus embodiment is provided. In this context, the communication of a sending unit with a receiving unit is controlled in a tire pressure monitoring system (TPMS). In embodiments, the sending unit sends a signal to the receiving unit in the context of a radio transmission. The receiving unit and/or sending unit are battery-operated, a threshold value receiver or carrier ID receiver being used as a receiving unit. The use of a threshold value receiver or carrier ID receiver makes it possible to keep the energy consumption of the receiving unit low. In further embodiments, the signal is of very uncomplicated configuration. In embodiments of the present invention, it is therefore not necessary to configure the signal with a start marker and/or an end marker. As a result of a simple signal configuration, one may use a sending unit of simple configuration, the latter likewise, requiring less energy than a sending unit of complex configuration.

In embodiments of the present invention, upon radio transmission of the signal, a first signal portion having at least one radio signal, and a second signal portion having at least one radio signal, are transmitted. In embodiments, the first signal portion is sent in a first time interval, and the second signal portion in the second time interval, from the sending unit to the receiving unit, both the first time interval and the second time interval being larger than is necessary for transmission of the radio signals in the respective time interval. This means that, for example, a gap can exist between two radio signals that are sent in one time interval. In that gap, for example, no radio signals are transmitted from the sending unit to the receiving unit, or in that gap the sending unit sends no signals, or in that gap the sending unit radiates no energy. In embodiments, because of the gap, the time interval consequently becomes larger than is necessary for the actual transmission of the radio signals without a gap. In embodiments, more than two, or only one, radio signal(s) can be sent in one of the time intervals, and gaps can occur between the radio signals in the context of a majority of radio signals. In embodiments, the gaps and the radio signals are distributed arbitrarily in the first and/or the second time interval. In embodiments, the gaps have a minimum length. For purposes of explaining some embodiments of the present invention, it will be assumed hereinafter that a plurality of radio signals are being transmitted.

In embodiments of the present invention, the radio signals received by the receiving unit are processed or not processed by the receiving unit as a function of the radio signal. If, for example, a threshold value receiver is used as a receiving unit, then the radio signals that exceed the threshold value are counted. In embodiments of the present invention, the receiving unit consequently processes those radio signals by counting those radio signals. If the radio signals do not exceed the threshold value the radio signals are, for example, not counted, and thus are not processed by the receiving unit. If a carrier ID receiver is used as a receiving unit, only the radio signals that have a specific carrier frequency (as carrier ID) are counted. In embodiments of the present invention, the receiving unit can also merely receive and forward the radio signals. In such an embodiment processing of the radio signals (for example as just described) can be handled by a different device.

In embodiments of the present invention, the apparatus embodiment changes its operating mode if a predefined number of radio signals is processed by the receiving unit in the first time interval and in the second time interval. For example, the measuring unit can be activated when the receiving unit has counted the same number of radio signals in the second time interval as in the first time interval. In this case, for example, measurement of the tire pressure can be accomplished by the measuring unit. The measured data can then, for example, be sent by the receiving unit when it has changed over into a sending mode.

In embodiments of the present invention, an apparatus embodiment does not change its operating mode when a number of radio signals deviating from the predefined number is processed by the receiving apparatus in the first time interval and in the second time interval. For example, if the number of radio signals counted in the second time interval is not equal to the number of radio signals counted in the first time interval, then, for example, no measurement of the tire pressure is carried out by the measuring unit. In this case, for example, the receiving unit remains in the receiving mode.

In embodiments of the present invention, different operating modes of the apparatus are selectable by way of the number of radio signals processed in the first time interval and in the second time interval. In embodiments, in this context, a change in the operating mode of an apparatus embodiment occurs only when the number of radio signals counted in the second time interval is equal to the radio signals counted in the first time interval. In embodiments, a predefined number of radio signals in the first and/or in the second time interval is allocated to each possible operating mode of an apparatus embodiment. For example, depending on the number of radio signals processed, a different operating mode of an apparatus embodiment is invoked or started in each case. For example, the apparatus can transition from an idle mode into a measurement mode when the number of radio signals counted in the first time interval and in the second time interval has equaled three in each case. For a quantity of, for example, two radio signals counted respectively in the first and in the second time interval, an apparatus embodiment can, for example, evaluate and send measured data, such as measured data of the tire pressure. In embodiments, if one radio signal is counted in the first time interval and in the second time interval, for example, the apparatus embodiment changes over into the idle mode. In embodiments of the present invention, it is also possible for only components of the apparatus embodiment to change their operating mode. For example, only the receiving unit can change over into an idle mode if one radio signal is counted in the first time interval and in the second time interval.

In embodiments of the present invention, the length of the first time interval and/or of the second time interval is defined. This can prevent radio signals sent in the first time interval from inadvertently being counted in the second time interval, or vice versa. In embodiments of the present invention, the length of the first and/or of the second time interval are determined by way of radio signals. For example, a “start” radio signal and/or an “end” radio signal can be sent by the sending unit, with the result that the length of the time intervals for the receiving unit is clearly delimited. A “start” and/or “end” radio signal of this kind can, for example, have a specific frequency or a specific transmission duration.

### BRIEF DESCRIPTION OF THE DRAWINGS

Exemplifying embodiments of the present invention are depicted in the drawings below.

FIG. 1 schematically depicts a receiving unit and a sending unit according to an embodiment of the present invention.

FIG. 2 schematically depicts a method for controlling an apparatus according to an embodiment of the present invention.

### DETAILED DESCRIPTION

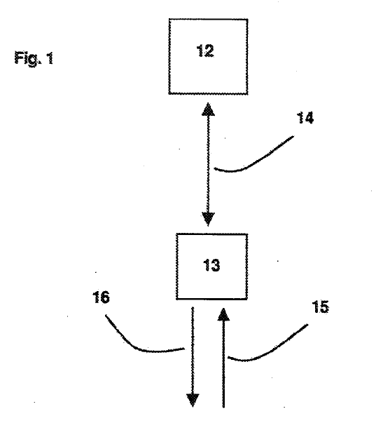

FIG. 1 schematically depicts a sending unit 12 and a receiving unit 13. In a method according to the present invention, sending unit 12 sends radio signals to receiving unit 13. Sending unit 12 can, however, also receive data from receiving unit 13, and receiving unit 13 can correspondingly send data to sending unit 12. Arrow 14 schematically depicts this bidirectional data exchange between receiving unit 13 and sending unit 12. Receiving unit 13 can, however, also receive data from other devices, as arrow 15 depicts. Receiving unit 13 can furthermore also send data to other devices, as arrow 16 depicts. Data transmission between receiving unit 13 and the other devices can occur in cable-based fashion and/or by way of a radio transmission. Another device can be, for example, a memory device that counts and/or stores the radio signals of sending unit 12.

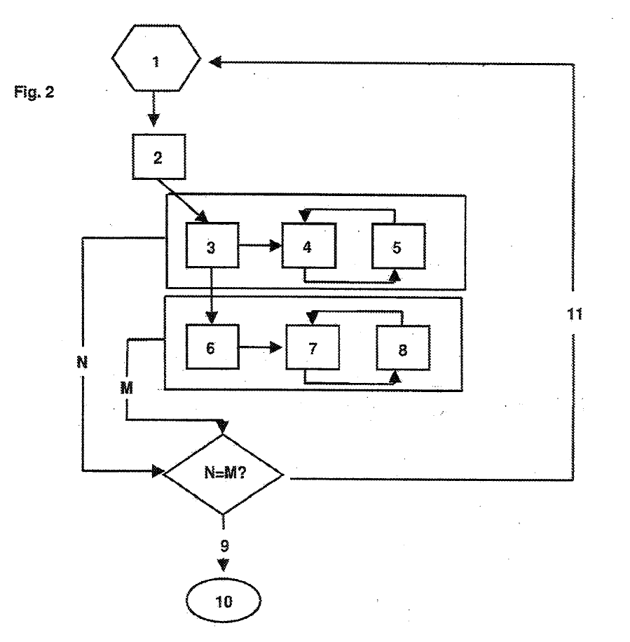

FIG. 2 schematically depicts an execution diagram of a method for controlling an apparatus according to an embodiment of the present invention. The method begins, for example, at step 1, in which receiving unit 13 waits for radio transmission of a signal from sending unit 12. In step 2, receiving unit 13 receives a first signal portion, the first signal portion being transmitted in a first time interval. Transmission of the first signal portion in the first time interval is represented by step 3. In the first time interval, for example, radio signals are transmitted as a first signal portion; the radio signals can be processed or not processed by receiving unit 13. In embodiments of the present invention, processing of the radio signals occurs in such a way that the number of radio signals that, for example, exceed a threshold value or exhibit a specific carrier frequency as a carrier ID is counted. Counting of these radio signals takes place in step 4. The number of radio signals counted in the first time interval is stored as, for example, value N. In embodiments, receiving unit 13 waits until the end of the first time interval for the transmission of further radio signals, as depicted by step 5. In embodiments, the second time interval begins with step 6. In embodiments, in step 7, radio signals are received in the second time interval. In embodiments of the present invention, these radio signals are counted if they exhibit the same carrier frequency, or exceed the same threshold value, as the radio signals in the first time interval. The number of radio signals counted is stored as, for example, value M. In embodiments, in step 8, all the radio signals received by the end of the second time interval are correspondingly counted or not. In embodiments, after the second time interval, values N and M are compared. At point 9, for example, the number of radio signals counted in the first and in the second time interval is the same. In embodiments, this is then followed by step 10 in which, for example, various operating modes of the apparatus are started.

In embodiments of the present invention, different operating modes of the apparatus are selectable in step 10 as a function of values N, M. If N and M denote, for example, three counted radio signals, then, for example, a measurement of a tire pressure of a vehicle is performed. In embodiments, if the number of radio signals counted in the first and in the second time interval is not the same, as depicted by point 11, no change occurs in the operating mode of the apparatus. Receiving unit 13 instead waits, for example, once again for the radio transmission of sending unit 12, as in step 1. In embodiments, there are as many different variations of values N, M as there are operating modes of the apparatus. For three operating modes of the apparatus, for example, three different numbers of radio signals can be stored as values N, M. As a result of the uncomplicated method, the apparatus according to the present invention can have an economical sending unit 12 and an economical receiving unit 13. In embodiments, the energy consumption of the receiving unit 13 and sending unit 12 that are used is very low, so that the apparatus can be operated using a battery for power supply or energy delivery purposes. In embodiments, because a change in the operating mode of the apparatus occurs only when a predefined number of counted radio signals is present in the first time interval and in the second time interval, the apparatus changes over into a different operating mode only in the context of a double query performed in such a fashion. In embodiments, the apparatus embodiment becomes more reliable as a result, since the probability of a changeover into an erroneous operating mode as a result of an erroneous signal transmission between sending unit 12 and receiving unit 13 is reduced. In embodiments, energy is saved at the same time as a result, since, for example, other components of the apparatus are not started in error if the apparatus is changed over into an erroneous operating mode. Such components can be, for example, microcontrollers.

1-12. (canceled)

13. An apparatus for processing and measuring vehicle data, comprising:
a receiving unit;
a sending unit; and
a measuring unit,
wherein at least one of the units is battery-operated, and the receiving unit is one of a threshold value receiver and a carrier identification receiver.

14. The apparatus as recited in claim 13, wherein the receiving unit is encompassed by wheel electronics of a vehicle.

15. The apparatus as recited in claim 13, wherein the apparatus has a trigger transmitter in the sending unit.

16. The apparatus as recited in claim 13, wherein the sending unit transmits at a frequency from approximately 80 to 250 kHz.

17. A receiving unit for use in an apparatus for processing and measuring vehicle data, comprising: the receiving unit having both a receiving mode and a sending mode; a sending unit; and a measuring unit, wherein at least one of the units is battery-operated, and the receiving unit is one of a threshold value receiver and a carrier identification receiver.

18. A method for controlling an apparatus for processing and measuring vehicle data, comprising:
sending a signal by a sending unit to a receiving unit by radio transmission;
providing that at least one of the sending unit and the receiving unit is battery-operated; and
using one of a threshold value receiver and a carrier identification receiver as the receiving unit,
wherein the apparatus includes the receiving unit, the sending unit, and a measuring unit, and at least one of the receiving unit, the sending unit and the measuring unit is battery-operated.

19. The method as recited in claim 18, further comprising:
upon radio transmission, transmitting a first signal portion having at least one radio signal and a second signal portion having at least one radio signal from the sending unit to the receiving unit,
wherein the first signal portion is transmitted in a first time interval, and the second signal portion is transmitted in a second time interval, both a length of the first time interval and a length of the second time interval being substantially larger than is necessary for transmission of each respective at least one radio signal in the respective time interval.

20. The method as recited in claim 19, further comprising:
processing by the receiving unit the received radio signals as a function of the radio signals.

21. The method as recited in claim 19, further comprising:
changing an operating mode of the apparatus if a predefined number of radio signals is processed by the receiving unit in the first time interval and in the second time interval.

22. The method as recited in claim 19, wherein the apparatus remains in its operating mode if a number of radio signals deviating from a predefined number is processed by the receiving unit in the second time interval and in the first time interval.

23. The method as recited in claim 19, further comprising:
defining the length of at least one of the first time interval and the second time interval.

24. The method as recited in claim 19, further comprising:
setting different operating modes of the apparatus as a function of a number of radio signals processed in the first time interval and the second time interval.

25. The method as recited in claim 19, wherein the receiving unit does not process the received radio signals as a function of the radio signals.

26. The apparatus of claim 13, wherein the vehicle data measured includes tire pressure data.

27. The apparatus as recited in claim 13, wherein the sending unit transmits at a frequency from approximately 110 to 150 kHz.

28. The apparatus as recited in claim 13, wherein the sending unit transmits at a frequency from approximately 120 to 130 kHz.
